(19) United States
(12) Patent Application Publication
(10) Pub. No.: US 2014/0137477 A1
(43) Pub. Date: May 22, 2014

(54) VEHICLE DOOR OPENING AND CLOSING APPARATUS

(71) Applicant: Aisin Seiki Kabushiki Kaisha, Kariya-shi (JP)

(72) Inventors: Kouji OOE, Kariya-shi (JP); Takeshi YAMAMOTO, Takahama-shi (JP); Kimihide KATO, Nisshin-shi (JP); Takayuki SENGOKU, Chiryu-shi (JP); Keisuke HARUTA, Kariya-shi (JP)

(73) Assignee: Aisin Seiki Kabushiki Kaisha, Kariya-shi (JP)

(21) Appl. No.: 14/079,777

(22) Filed: Nov. 14, 2013

(30) Foreign Application Priority Data
Nov. 16, 2012 (JP) 2012-252636

(51) Int. Cl. E05F 15/12

(52) U.S. Cl. CPC E05F 15/124
USPC 49/358

(57) ABSTRACT

A vehicle door opening and closing apparatus includes: a supporting member having an expandable and contractible shape and configured to be capable of holding a door at an opened position by being interposed between a body and the door, a socket provided on at least one of shaft end portions of the supporting member and configured to form a rotation coupling point of the supporting member by being fitted into a ball-shaped fitting portion at a coupling portion with respect to the supporting member, and a retaining ring provided in a fitting depression of the socket and capable of retaining the ball-shaped fitting portion in the fitting depression by reducing a diameter of the opening portion of the fitting depression. The socket is demountable from the shaft end portion in a state of being fitted to the ball-shaped fitting portion.

### CROSS REFERENCE TO RELATED APPLICATIONS

This application is based on and claims priority under 35 U.S.C. §119 to Japanese Patent Application 2012-252636, filed on Nov. 16, 2012, the entire content of which is incorporated herein by reference.

### TECHNICAL FIELD

This disclosure relates to a vehicle door opening and closing apparatus.

### BACKGROUND DISCUSSION

In the related art, there is a vehicle door opening and closing apparatus provided with a supporting member having an expandable shaft shape and configured to be capable of retaining a door at an opened position by being interposed between a body and a door of a vehicle. Normally, in the vehicle door opening and closing apparatus configured as described above, the supporting member is rotatably coupled to the door and the body at axial both ends thereof. The supporting member allows opening and closing action of the vehicle door by expanding and contracting while relatively rotating about a rotation coupling point thereof.

For example, JP No. 4430044 (Reference 1) discloses a configuration in which a drive unit configured to cause the supporting member to expand and contract is integrated in the supporting member. The supporting member is provided with sockets at shaft end portions configured to form the rotation coupling points by ball-shaped fitting portions provided respectively at coupling portions of the door and the body.

In other words, the supporting member being freely rotatable with a simple configuration is achieved by forming the rotation coupling points by ball joints formed by fitting the sockets to the ball-shaped fitting portions. The supporting member improves efficiency of a mounting operation with respect to the vehicle by utilizing the high assembleability thereof.

By employing such a configuration, however, although a wide movable range and easiness of assembly of the supporting member can be secured, both of retention of the coupled state and ease of maintenance can hardly be achieved simultaneously after having mounted on the vehicle.

In other words, retaining the ball-shaped fitting portions in the fitting depressions formed on the socket is important for the maintenance of the coupled state. In order to do so, for example, retaining rings expandable and contractible by their own resilient deformation are fitted to the openings of the fitting depressions. Accordingly, the openings of the fitting depressions are reduced in diameter, so that the ball-shaped fitting portions may be retained in the fitting depressions while securing the wide movable range and ease of assembly (for example, see JP No. 4364725 (Reference 2)).

However, the reduction in diameter of the openings of the fitting depressions as described above makes decoupling of the ball-shaped fitting portions from the fitting depressions difficult after having mounted on the vehicle. In particular, in the configuration in which the drive unit is integrated in the supporting member as described in Reference 1, since the ease of maintenance after having mounted is important, there remains a room for improvement.

### SUMMARY

Thus, a need exists for a vehicle door opening and closing apparatus which is not suspectable to the drawback mentioned above.

An aspect of this disclosure provides a vehicle door opening and closing apparatus including: a supporting member having an expandable and contractible shaft shape and configured to be capable of holding a door at an opened position by being interposed between a body and a door of a vehicle, a socket provided on at least one of shaft end portions of the supporting member and configured to form a rotation coupling point of the supporting member by being fitted into a ball-shaped fitting portion provided at a coupling portion with respect to the supporting member, and a retaining ring provided in a fitting depression of the socket and capable of retaining the ball-shaped fitting portion in the fitting depression by reducing the diameter of the opening portion of the fitting depression, wherein the socket is demountable from the shaft end portion of the supporting member in a state of being fitted to the ball-shaped fitting portion.

According to the configuration as described above, pulling out of the ball-shaped fitting portion arranged in the fitting depression is restricted by the retaining ring provided in the fitting depression of the socket. Accordingly, a coupled state of each of the supporting members may be maintained by the ball-shaped fitting portion held in the fitting depression. Therefore, ease of maintenance is desirably secured by enabling the socket in a fitted state to the ball-shaped fitting portion to be demounted from the shaft end portion of the supporting members.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle door opening and closing apparatus;

FIG. 2 is a side view of the supporting member;

FIG. 3 is a cross-sectional view of the supporting member;

FIG. 4 is a cross-sectional view of a socket to fit on a ball head portion of a ball stud;

FIG. 5 is a perspective view of the socket;

FIG. 6 is a cross-sectional view of a shaft end portion and a socket of the supporting member;

FIG. 7 is a cross-sectional view of the shaft end portion and the socket of the supporting member; and

FIG. 8 is an explanatory drawing for explaining an operation of a fitting groove formed in the fitting depression and a C-ring arranged in the fitting groove.

### DETAILED DESCRIPTION

Referring now to the drawings, an embodiment disclosed here will be described with reference to the drawings.

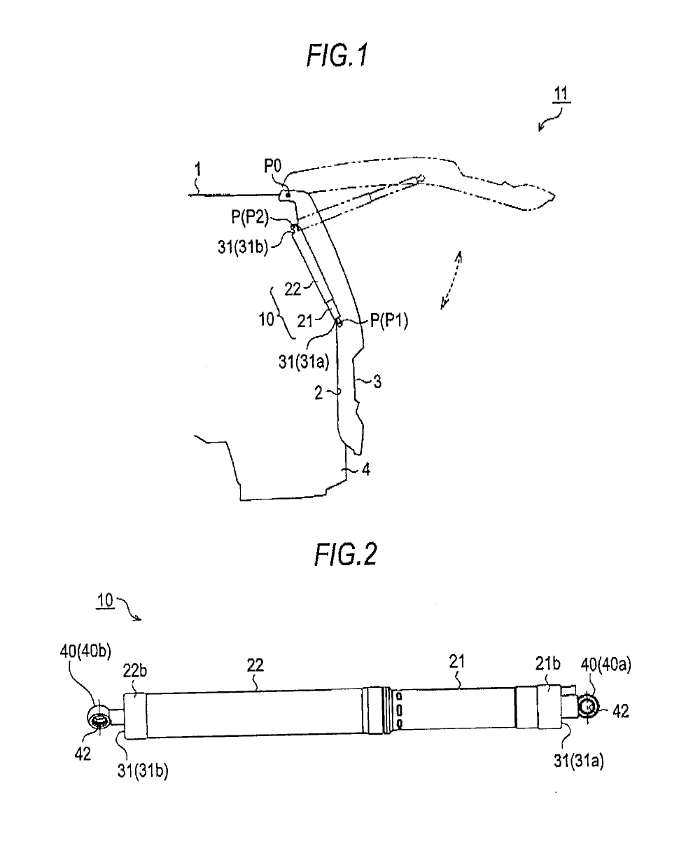

As illustrated in FIG. 1, a door opening 2 formed at a rear portion of a vehicle 1 is provided with a back door 3 configured to be opened and closed about a supporting point P0 set at an upper end portion thereof as a center of rotation, which is of so-called a hatchback type. Provided on widthwise both ends of the door opening 2 are supporting members 10 having an expandable and contractible shaft shape and configured to be capable of retaining an opened position of the back door 3 by being interposed between the back door 3 and the body 4. In the embodiment disclosed here, a power back door apparatus 11 configured to cause the back door 3 to be opened and closed with the supporting members 10 as actuators is formed.

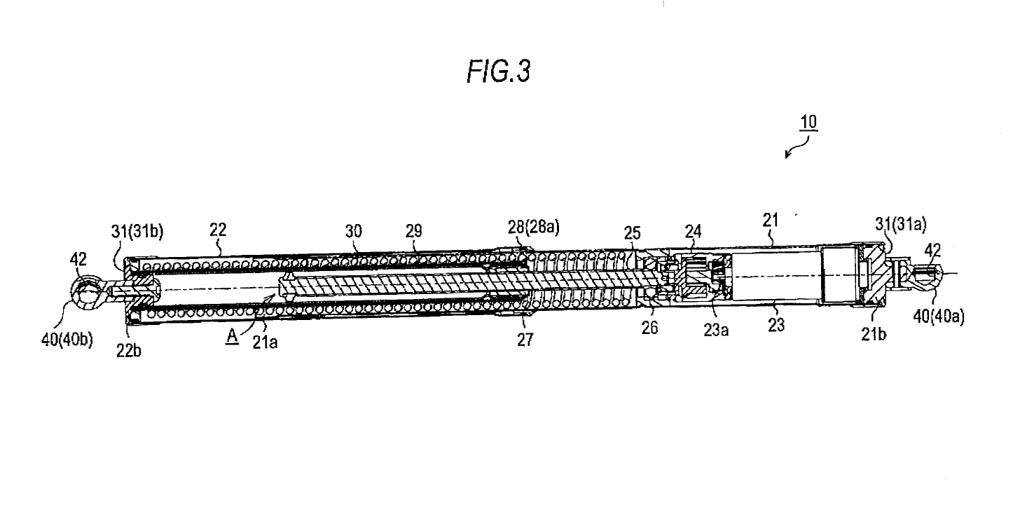

Specifically, as illustrated in FIGS. 2 and 3, the supporting member 10 of the embodiment disclosed here each include a first housing 21 and a second housing 22 having diameters different from each other and both formed into a bottomed substantially cylindrical shape. The first housing 21 and the second housing 22 are arranged concentrically so as to be expandable and contractible in the axial direction thereof.

A motor 23, which corresponds to a drive source, is accommodated in the interior of the first housing 21, which is coaxially inserted into the second housing 22 at an opening end 21a by being formed to have a diameter smaller than the second housing 22. Furthermore, a screw spindle 25 extending coaxially is coupled to a motor shaft 23a thereof via a decelerator 24. In the embodiment disclosed here, a proximal end portion of the screw spindle 25 is axially supported by a ball bearing 26. The second housing 22 is provided with a spindle nut 27 screwed onto the screw spindle 25.

Specifically, a first guide tube 28 having a substantially cylindrical shape is coaxially fixed to the inside of the second housing 22. The screw spindle 25 described above is inserted at a distal end thereof into the first guide tube 28. The spindle nut 27 is fixed to an opening end 28a (an end on the right side in FIG. 3) of the first guide tube 28.

In this manner, in the embodiment disclosed here, each of the supporting members 10 includes a drive unit A which is capable of expanding and contracting the supporting member 10 with the motor 23 integrated therein as a drive source. In other words, in association with the rotation of the screw spindle 25 by being driven by the motor, the spindle nut 27 screwed onto the screw spindle 25 apparently moves axially on the screw spindle 25 (screw pair). The supporting members 10 of the embodiment disclosed here are allowed to change the axial length thereof by the relative movement of the first housing 21 and the second housing 22 in the axial direction.

Further specifically, in the embodiment disclosed here, a second guide tube 29 having a diameter larger than the first guide tube 28 is concentrically arranged in the interior of the second housing 22. A compression coil spring 30 is fitted on the outer periphery of the second guide tube 29. One end of the compression coil spring 30 abuts against a bottom portion 22b of the second housing 22 and the other end of the compression coil spring 30 abuts against the ball bearing 26 on the first housing 21.

As illustrated in FIG. 1, in the embodiment disclosed here, each of the supporting members 10 configured as described above is rotatably coupled to the back door 3 and the body 4 so that shaft end portion 31 (31a and 31b) is freely rotatable. Specifically, the shaft end portion 31a of the first housing 21 is coupled to the back door 3, and the shaft end portion 31b of the second housing 22 is coupled to the body 4. Each of the supporting members 10 expands and contracts while rotating about the rotation coupling point P (P1 and P2) relative to the back door 3 and the body 4 and hence allows the back door 3 to open and close.

In other words, the power back door apparatus 11 of the embodiment disclosed here allows the back door 3 to open by expanding the axial length of the supporting members 10 on the basis of the drive forces of the motors 23 provided in the interior of the respective supporting members 10. The power back door apparatus 11 also allows the back door 3 to close by contracting the axial length of the supporting members 10. The opened position of the back door 3 may be retained by maintaining the axial length of the supporting members 10 (the expanded or contracted length) on the basis of resilient forces of the compression coil springs 30 accommodated in the interiors of the cylinders.

### (Coupling Structure of Supporting Members)

Subsequently, the coupling structure of each of the supporting members 10 configured as described above will be described.

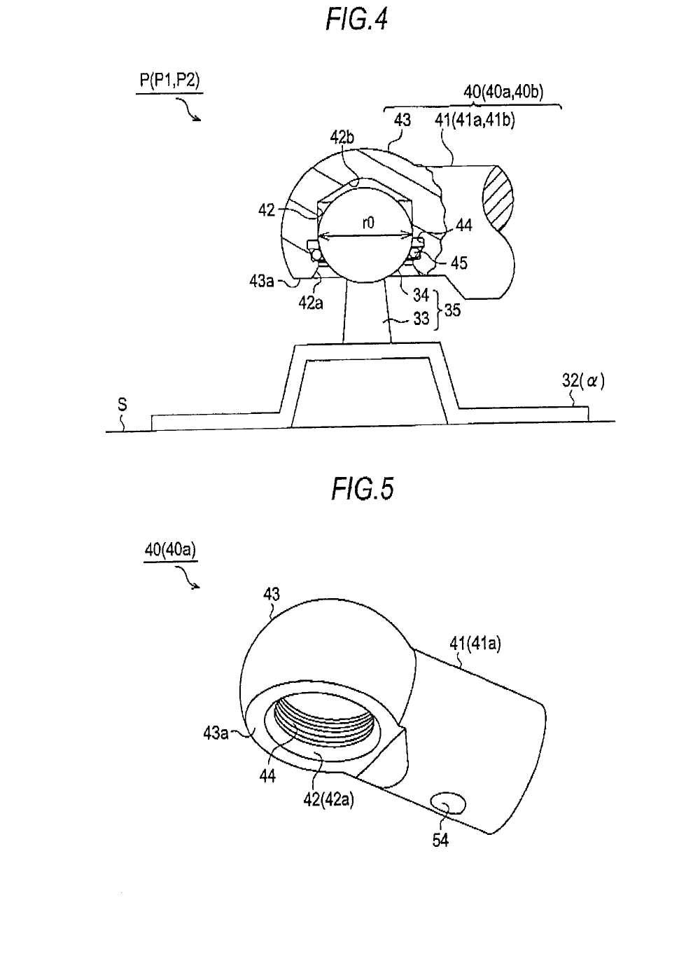

As illustrated in FIG. 4, each of panel surfaces S of the back door 3 and the body 4 is provided with a coupling bracket 32 which constitutes coupled portion α with respect to each of the supporting members 10. Specifically, each of the coupling bracket 32 is provided with a ball stud 35 including a shaft portion 33 projecting in a direction substantially orthogonal to the panel surface S and a ball head portion 34 provided at a distal end of the shaft portion 33. The shaft end portion 31 (31a and 31b) of the each of the supporting members 10 is provided with a socket 40 (40a and 40b) configured to form the rotation coupling point P (P1 and P2) of each of the supporting members 10 by fitting onto the ball head portions 34, which respectively correspond to the ball-shaped fitting portions thereof.

Specifically, as illustrated in FIG. 4 to FIG. 7, the socket 40 (40a and 40b) on each of the first housing 21 and on the second housing 22 includes a substantially column shaped shaft portion 41 to be mounted on the shaft end portion 31 (31a, 31b), and a socket portion 43 having a fitting depression 42 configured to fit the ball head portion 34 of the ball stud 35 and being provided at a distal end of the shaft portion 41.

The socket portion 43 of the embodiment disclosed here has a substantially semi-ball-shaped outline having a flat surface 43a substantially parallel to an axial line of the shaft portion 41, and the fitting depression 42 is formed on the flat surface 43a of the socket portion 43 so as to be depressed therefrom. An opening 42a of the fitting depression 42, which has a substantially circular shape is formed with an annular-shaped fitting groove 44 on an inner periphery thereof so as to be depressed therefrom, and a C-ring 45 having a circular shape with partly discontinuous portion is fitted into the fitting groove 44. In the embodiment disclosed here, the ball head portion 34 of the ball stud 35 is retained in the fitting depression 42 by reducing the diameter of the opening 42a of the fitting depression 42 by the C-ring 45 expandable and contractible by resilient deformation thereof.

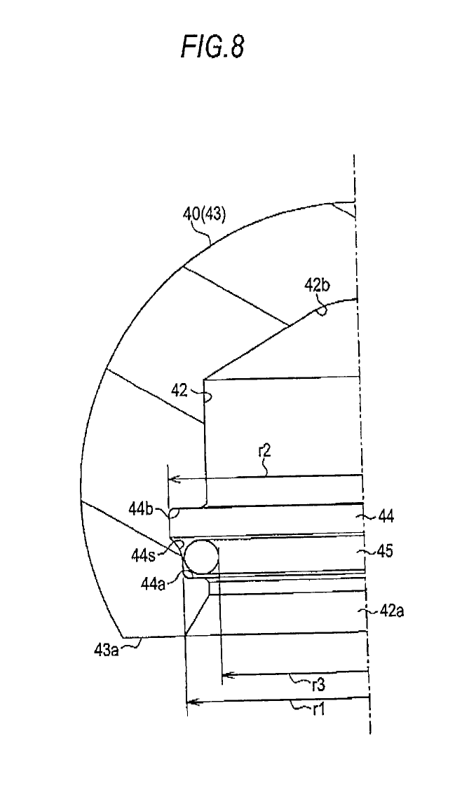

As illustrated in FIG. 8, the fitting groove 44 of the embodiment disclosed here has a width (the length in the vertical direction in FIG. 8) which allows the C-ring 45 as the retaining ring arranged in the fitting groove 44 to move in the axial direction. The fitting groove 44 also has a tapered surface 44s increasing in diameter from the opening 42a side toward the bottom portion 42b of the fitting depression 42. The C-ring 45 abuts against a side wall 44a of the fitting groove 44 on the side of the opening 42a, so that the axial movement toward the opening 42a, that is, the axial movement in a direction of coming apart from the fitting groove 44 is restricted.

In the embodiment disclosed here, an inner diameter r1 of the fitting groove 44 in the vicinity of the side wall 44a on the side of the opening 42a is set to a value which does not allow an inner diameter r3 of the C-ring 45 to be increased beyond a diameter r0 of the ball head portion 34 fitting to the fitting depression 42 (see FIG. 4). An inner diameter r2 of the fitting groove 44 in the vicinity of the side wall 44b on the side of the bottom portion 42b is set to a value which allows the inner diameter r3 of the C-ring 45 to increase beyond the diameter r0 of the ball head portion 34.

In other words, when mounting each of the supporting members 10 to the back door 3 and the body 4, the C-ring 45 arranged in the fitting groove 44 moves in the fitting groove 44 from the opening 42a side toward the bottom portion 42b (moved from the lower side to the upper side in FIG. 8) while being increased in diameter by being expanded outward by being pressed by the ball head portion 34 inserted from the opening 42a into the fitting depression 42. The ball head portion 34 is configured in such a manner that the largest diameter portion thereof (see FIG. 1, a portion showing a diameter r0) is allowed to move toward the bottom portion 42b of the fitting depression 42 beyond the C-ring 45 by the increase in diameter of the C-ring 45.

The C-ring 45, being arranged on the side of the opening 42a of the fitting depression 42 with respect to a largest diameter portion of the ball head portion 34, moves in the fitting groove 44 from the bottom portion 42b side to the opening 42a side while being reduced in diameter so as to follow a ball-shaped surface of the ball head portion 34 (moves from the upper side toward the lower side in FIG. 8). The C-ring 45 comes into abutment with the side wall 44a and hence is restricted in axial movement toward the opening 42a side, so that the movement of the ball head portion 34 toward the opening 42a is restricted. In other words, the ball head portion 34 is restricted from coming apart, and is retained in the fitting depression 42.

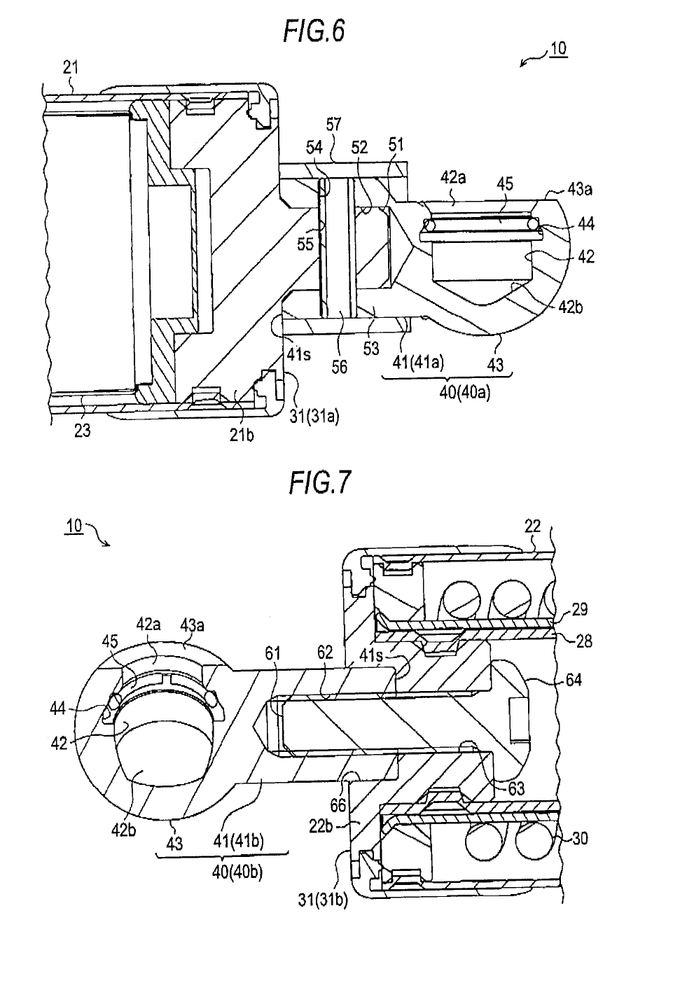

Further specifically, as illustrated in FIG. 6, a projecting fitting portion 51 having a substantially column shape projecting from the bottom portion 21b of the first housing 21 in the axial direction is formed on the shaft end portion 31a of the side of the first housing 21 of each of the supporting members 10. The socket 40a to be mounted on the shaft end portion 31a is formed with a fitting hole 52 which allows insertion of the projecting fitting portion 51.

Specifically, the fitting hole 52 of the socket 40a is formed so as to follow the axial line of the shaft portion 41a from the shaft end surface 41s of the shaft portion 41a (rightward in FIG. 6). The shaft portion 41a of the socket 40a formed with the fitting hole 52 is formed with a through hole 54 penetrating through the shaft portion 41a in a direction intersecting the axial line thereof (the vertical direction in FIG. 6), specifically, penetrating through the wall portion 53 of the fitting hole 52. Furthermore, the projecting fitting portion 51 of the shaft end portion 31a to be inserted into the fitting hole 52 is also formed with a through hole 55 penetrating through the projecting fitting portion 51 in a direction intersecting the axial line thereof (the vertical direction in FIG. 6) at a position corresponding to the through hole 54 formed in the shaft portion 41a. A fixing pin 56, which corresponds to a fixing member for fixing the projecting fitting portion 51 in the fitting hole 52 by being arranged so as to extend across the wall portion of the fitting hole 52 and the projecting fitting portion 51 is inserted into the through holes 54 and 55.

In the embodiment disclosed here, the inner diameter of the fitting hole 52 is set to be substantially the same as the diameter of the projecting fitting portion 51. The axial length of the fixing pin 56 is set to be substantially the same as the diameter of the shaft portion 41a. A cover 57 configured to retain the fixing pin 56 in the through holes 54 and 55 by surrounding the outer periphery of the shaft portion 41a is attached on the socket 40a.

In contrast, as illustrated in FIG. 7, a screw shaft 61 projecting from the bottom portion 22b of the second housing 22 in the axial direction is provided on the shaft end portion 31b of the second housing 22 of each of the supporting members 10. The socket 40b to be attached to the shaft end portion 31b is formed with a screw hole 62 in which the screw shaft 61 is screwed.

Specifically, the screw hole 62 of the socket 40b is formed so as to follow the axial line of the shaft portion 41b from the shaft end surface 41s of the shaft portion 41b (leftward in FIG. 7). The screw shaft 61 of the shaft end portion 31b is formed by screwing a bolt 64 from the inside of the cylinder (the right side in FIG. 7) into the screw hole 63 formed on the bottom portion 22b of the second housing 22 so as to penetrate through the bottom portion 22b. In other words, the bolt 64 which constitutes the screw shaft 61 is screwed into the screw hole 62 of the socket 40b via the screw hole 63. Accordingly, the socket 40b is tightened to the shaft end portion 31b of the supporting members 10 in a form in which the shaft portion 41b projects from the bottom portion 22b of the second housing 22.

In the embodiment disclosed here, the bottom portion 22b of the second housing 22 is formed with a depression 66 in which a portion of the shaft portion 41b of the socket 40b in the vicinity of the shaft end surface 41s is inserted. In the depression 66, a retaining structure which restricts the rotation of the shaft portion 41b inserted into the depression 66 (so called a bolt width fitting structure) is formed.

Subsequently, an operation of the coupling structure of the supporting members 10 will be described. In other words, the C-ring 45 fitted to the fitting depression 42 of the socket 40 (40a and 40b) holds the ball head portion 34 into the fitting depression 42 by reducing the diameter of the opening 42a to restrict the ball head portion 34 inserted into the fitting depression 42 from coming apart therefrom.

The socket 40a is attached to the shaft end portion 31a in a form in which the projecting fitting portion 51 formed on the shaft end portion 31a on the side of the first housing 21 is inserted into the fitting hole 52 formed in the shaft portion 41a. The socket 40a is fixed to the shaft end portion 31a of the first housing 21 by the projecting fitting portion 51 inserted into the fitting hole 52 fixed to the fitting hole 52 by the fixing pin 56 penetrating though the projecting fitting portion 51 and the shaft portion 41a of the socket 40a (the wall portion 53 of the fitting hole 52).

Subsequently, the socket 40 in a state of being fitted to the ball head portion 34 is allowed to be removed from the shaft end portion 31a by pulling out the fixing pin 56 interposed between the (through hole 54 of the) shaft portion 41a and the (through hole 55) of the projecting fitting portion 51 of the shaft end portion 31a.

As described above, according to the embodiment disclosed herein, the following effects are achieved.

(1) The shaft end portion 31 of each of the supporting members 10 is provided with the socket 40 (40a and 40b) configured to form the rotation coupling point P (P1 and P2) of each of the supporting members 10 by fitting onto the ball head portions 34 of the ball stud 35 provided at the coupled portion α with respect to each of the supporting members 10. The C-ring 45, which corresponds to the retaining ring, capable of retaining the ball head portion 34, which corresponds to the ball-shaped fitting portion, in the fitting depression 42 by reducing the diameter of the opening 42a is provided in the fitting depression 42 of the socket 40. The socket 40 (40a) is formed so as to be demountable from the shaft end portion 31 of each of the supporting members 10 in a state in which the ball head portion 34 is fitted thereto.

According to the configuration as described above, pulling out of the ball head portion 34 arranged in the fitting depression 42 is restricted by the C-ring 45 provided in the fitting depression 42 of the socket 40. Accordingly, a coupling state of each of the supporting members 10 may be maintained by the ball head portion 34 held in the fitting depression 42. Therefore, ease of maintenance is desirably secured by enabling the socket 40a in a fitted state to the ball head portion 34 to be demounted from the shaft end portion 31a of the supporting members 10.

(2) The shaft end portion 31a of each of the supporting members 10 is formed with the projecting fitting portion 51 projecting in the axial direction, and the socket 40a which forms the rotation coupling point P1 with respect to the back door 3 by being mounted on the shaft end portion 31a is formed with the fitting hole 52 which allows insertion of the projecting fitting portion 51. The wall portion 53 of the fitting hole 52 and the projecting fitting portion 51 are formed respectively with the through holes 54 and 55 penetrating through the wall portion 53 and the projecting fitting portion 51 inserted into the fitting hole 52. The fixing pin 56 penetrating through the wall portion 53 of the fitting hole 52 and the projecting fitting portion 51 is inserted into the through holes 54 and 55.

With this configuration, the projecting fitting portion 51 is fixed in the fitting hole 52 by the fixing pin 56 arranged so as to extend across the wall portion 53 of the fitting hole 52 and the projecting fitting portion 51. Accordingly, the axial movement of the socket 40a with respect to the shaft end portion 31a of each of the supporting members 10 and the rotation of the socket 40a around the axial line are restricted. In other words, the fixing pin 56 functions both as a retaining member and a detent member. Then, in a state in which the socket 40a is fitted to the ball head portion 34, the socket 40a can be demounted easily and quickly from the shaft end portion 31a by pulling out the fixing pin 56 from the through holes 54 and 55.

(3) Each of the supporting members 10 includes a drive unit A which is capable of expanding and contracting the supporting member 10 with the motor 23 as the drive source. In other words, in a configuration in which the drive unit A is integrated in each of the supporting members 10, the ease of maintenance after having been mounted on the vehicle 1 is important. Therefore, remarkable effects are achieved by applying the configuration of the embodiment disclosed here to such a configuration.

The embodiment disclosed here may be modified as described below.

In the embodiment described above, the configuration of this disclosure is embodied in the power back door apparatus 11 configured to cause the back door 3 of the vehicle 1 to open and close. However, the above-described configuration may be embodied in other vehicle door opening and closing apparatuses.

In the embodiment described above, the supporting members 10 are provided at both ends of the door opening 2 in the width direction. However, the number of the supporting members 10 may be one, or three or more.

In the embodiment described above, the configuration of this disclosure is embodied in the configuration in which the drive unit A is integrated in each of the supporting members 10. However, application of the configuration of this disclosure is not limited thereto, and may be embodied in the configuration in which the drive unit A is not integrated in each of the supporting members 10. The damper structure for holding the opening position of the back door 3 is not limited to the structure using a resilient force of the compression coil spring 30, and may be a structure having a gas-system damper mechanism.

In the embodiment described above, the shaft end portion 31a at one end of each of the supporting members 10 is configured to be fixed to the fitting hole 52 by inserting the projecting fitting portion 51 projecting from the shaft end portion 31a into the fitting hole 52 of the socket 40a and inserting the fixing pin 56 so as to penetrate through the wall portion 53 of the fitting hole 52 and the projecting fitting portion 51. The shaft end portion 31b on the other side is provided with the screw shaft 61 on the shaft end portion 31b and the socket 40b mounted on the shaft end portion 31b is formed with the screw hole 62 configured to be screwed on the screw shaft 61. However, this disclosure is not limited thereto, and a configuration in which the sockets 40a are fixed to both of the shaft end portions 31 by fitting between the projecting fitting portion 51 and the fitting hole 52 and the fixing pins 56 penetrating therethrough is also applicable.

Furthermore, in the configuration in which the socket 40a as described above is provided only on either one of the shaft end portions 31 of the supporting member 10, a configuration in which the rotation coupling points P of the corresponding supporting member 10 are formed by a coupling structure other than the fitting between the ball-shaped fitting portion and the socket 40 as described above at the shaft end portion 31 on the other side is also possible.

In the embodiment described above, the socket 40 is fitted to the ball head portion 34 of the ball stud 35 provided on the coupling bracket 32 which constitute the coupled portion α with respect to each of the supporting members 10. However, this disclosure is not limited thereto, and any supporting structure of the ball-shaped fitting portion may be employed as long as the ball-shaped fitting portion can form the rotation coupling points P of the supporting member 10 by fitting to the socket 40.

In the embodiment described above, the projecting fitting portion 51 is provided on the shaft end portion 31 (31a) of each of the supporting members 10, and the fitting hole 52 is provided on the socket 40 (40a). However, a configuration in which the projecting fitting portion 51 is provided on the socket 40 and the projecting fitting portion 51 is provided on the shaft end portion 31 is also applicable.

In the embodiment described above, the screw shaft 61 is provided on the shaft end portion 31 (31b) of each of the supporting members 10, and screw hole 62 is provided on the socket 40 (40b). However, a configuration in which the screw shaft 61 is provided on the socket 40 and the screw hole 62 is provided on the shaft end portion 31 is also applicable.

In the embodiment described above, the projecting fitting portion 51 includes the substantially column shaped outline extending from the bottom portion 21b of the first housing 21 in the axial direction. However, the shape of the projecting fitting portion 51 and the shape of the fitting hole 52 in which the projecting fitting portion 51 is inserted may be modified arbitrarily.

In the embodiment described above, the C-ring 45 is used as the retaining ring. However, this disclosure is not limited thereto, and a configuration in which other members such as an O ring which is expandable and contractible in the same manner as the C-ring 45, for example, may be used as long as it is a ring member which reduces the diameter of the opening 42a of the fitting depression 42 to retain the ball head portion 34, which corresponds to the ball-shaped fitting portion, in the fitting depression 42.

In the embodiment described above, the wall portion 53 of the fitting hole 52 and the projecting fitting portion 51 are formed respectively with the through holes 54 and 55 penetrating through the wall portion 53 of the fitting hole 52 and the projecting fitting portion 51 inserted into the fitting hole 52. The fixing pin 56 penetrating through the wall portion 53 of the fitting hole 52 and the projecting fitting portion 51 is inserted into the through holes 54 and 55. However, this disclosure is not limited thereto, and the fixing structure on the basis of the fixing member may be modified arbitrarily as long as the ball head portion 34, which corresponds to the projecting fitting portion, can be fixed into the fitting hole 52 and can be demounted and mounted with respect thereto by being interposed between the wall portion 53 of the fitting hole 52 and the projecting fitting portion 51.

For example, a configuration in which a wedge shaped fixing member can be inserted into a radial gap between the wall portion 53 of the fitting hole 52 and the projecting fitting portion 51. A configuration in which the socket 40 can be demounted from the shaft end portion 31 of the supporting member 10 in a state of being fitted to the ball-shaped fitting portion in a structure other than that using the projecting fitting portion 51, the fitting hole 52, and the fixing member as described above is not excluded.

Alternatively, a weakest portion may provided on the coupling bracket 32 which constitutes the coupled portion α with respect to each of the supporting members 10 to cause the weakest portion to be broken when a large load input is given such as a case of vehicle collision. In this configuration, even when the maintenance or inspection is needed, the socket 40 can be demounted easily and quickly. Accordingly, ease of maintenance is preferably secured.

In particular, when employing the configuration of the embodiment described above, the weakest portion may be provided on the coupling bracket 32 on the back door 3. In other words, the socket 40a which constitutes the rotation coupling point P1 with respect to the back door 3 is fixed to the shaft end portion 31a of each of the supporting members 10 by fitting between the projecting fitting portion 51 and the fitting hole 52 and the fixing pin 56 penetrating therethrough. Therefore, by pulling out the fixing pin 56, the socket 40a can be demounted quickly.

Furthermore, as regards the detent structure of the socket 40b mounted on the shaft end portion 31b of each of the supporting members 10, for example, a configuration in which the detent can be released from the outside of each of the supporting members 10 by an insertion of the wedge member which is demountably mounted between the shaft portion 41b and the depression 66. Accordingly, further ease of maintenance is preferably secured.

A first aspect of this disclosure provides a vehicle door opening and closing apparatus including: a supporting member having an expandable and contractible shaft shape and configured to be capable of holding a door at an opened position by being interposed between a body and a door of a vehicle, a socket provided on at least one of shaft end portions of the supporting member and configured to form a rotation coupling point of the supporting member by being fitted into a ball-shaped fitting portion provided at a coupling portion with respect to the supporting member, and a retaining ring provided in a fitting depression of the socket and capable of retaining the ball-shaped fitting portion in the fitting depression by reducing the diameter of the opening portion of the fitting depression, wherein the socket is demountable from the shaft end portion of the supporting member in a state of being fitted to the ball-shaped fitting portion.

According to the configuration as described above, pulling out of the ball-shaped fitting portion arranged in the fitting depression is restricted by the retaining ring provided in the fitting depression of the socket. Accordingly, a coupled state of each of the supporting members may be maintained by the ball-shaped fitting portion held in the fitting depression. Therefore, ease of maintenance is desirably secured by enabling the socket in a fitted state to the ball-shaped fitting portion to be demounted from the shaft end portion of the supporting members.

A second aspect of this disclosure provides the vehicle door opening and closing apparatus described above, wherein a demountable and mountable fixing member configured to fix the projecting fitting portion in the fitting hole by being interposed between the projecting fitting portion and the wall portion of the fitting hole is provided.

In this configuration, the socket can be mounted and fixed to the shaft end portion of the supporting member easily. Also, even in a state in which the socket is fitted on the ball-shaped fitting portion, the socket can be demounted from the shaft end portion easily by demounting the fixing member. Accordingly, ease of maintenance is preferably secured.

A third aspect of this disclosure provides the vehicle door opening and closing apparatus described above, wherein the wall portion of the fitting hole and projecting fitting portion are formed with through holes penetrating through the wall portion of the fitting hole and the projecting fitting portion inserted into the fitting hole, and the fixing member is arranged so as to extend across the wall portion of the fitting hole and the projecting fitting portion by being inserted into the through hole.

With this configuration, the projecting fitting portion is fixed in the fitting hole by the fixing member arranged so as to extend across the wall portion of the fitting hole and the projecting fitting portion. In this configuration, the socket can be fixed to the shaft end portion of the supporting member reliably. Also, even in a state in which the socket is fitted on the ball-shaped fitting portion, the socket can be demounted from the shaft end portion easily and quickly by pulling out the fixing member from the through hole.

A fourth aspect of this disclosure provides the vehicle door opening and closing apparatus described above, wherein a cover configured to retain the fixing member in the through holes by surrounding the outer periphery of a shaft portion of the socket is attached on the socket.

In other words, the fixing member can be retained in the through holes by the cover.

A fifth aspect of this disclosure provides the vehicle door opening and closing apparatus described above, wherein the socket which can be demounted from the shaft end portion of the supporting member in a state of being fitted onto the ball-shaped fitting portion is provided at one of the shaft end portions of the supporting member.

In other words, the ease of maintenance of the supporting member is significantly increased by being capable of releasing the coupling with respect to at least one of the door and body. Therefore, with the configuration described above, the ease of maintenance may be improved with a simple structure.

A sixth aspect of this disclosure provides the vehicle door opening and closing apparatus described above, wherein the supporting member includes a drive unit having a drive source and capable of expanding and contracting the supporting member integrated therein.

In other words, in a configuration in which the drive unit is integrated in the supporting member, the ease of maintenance after having been mounted on the vehicle is important. Therefore, remarkable effects are achieved by applying the configuration of the embodiment disclosed here to such a configuration.

According to the aspects of this disclosure, both of the retention of the coupled state and the preferable ease of maintenance are achieved simultaneously after having mounted the supporting member on the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door opening and closing apparatus comprising;
a supporting member having an expandable and contractible shape and configured to be capable of holding a door at an opened position by being interposed between a body and the door of a vehicle,
a socket provided on at least one of shaft end portions of the supporting member and configured to form a rotation coupling point of the supporting member by being fitted into a ball-shaped fitting portion provided at a coupling portion with respect to the supporting member, and
a retaining ring provided in a fitting depression of the socket and capable of retaining the ball-shaped fitting portion in the fitting depression by reducing a diameter of the opening portion of the fitting depression, wherein
the socket is demountable from the shaft end portion of the supporting member in a state of being fitted to the ball-shaped fitting portion.

2. The vehicle door opening and closing apparatus according to claim 1, wherein
one of the socket and the shaft end portion to which the socket is mounted is formed with a projecting fitting portion, and the other one of the socket and the shaft end portion is formed with a fitting hole in which the projecting fitting portion is inserted, and
a demountable and mountable fixing member configured to fix the projecting fitting portion in the fitting hole by being interposed between the projecting fitting portion and a wall portion of the fitting hole.

3. The vehicle door opening and closing apparatus according to claim 2, wherein
the wall portion of the fitting hole and projecting fitting portion are formed with through holes penetrating through the wall portion of the fitting hole and the projecting fitting portion inserted into the fitting hole, and the fixing member is arranged so as to extend across the wall portion of the fitting hole and the projecting fitting portion by being inserted into the through holes.

4. The vehicle door opening and closing apparatus according to claim 3, wherein
a cover configured to retain the fixing member in the through holes by surrounding the outer periphery of a shaft portion of the socket is attached on the socket.

5. The vehicle door opening and closing apparatus according to claim 1, wherein
the socket which can be demounted from the shaft end portion of the supporting member in a state of being fitted onto the ball-shaped fitting portion is provided at one of the shaft end portions of the supporting member.

6. The vehicle door opening and closing apparatus according to claim 2, wherein
the socket which can be demounted from the shaft end portion of the supporting member in a state of being fitted onto the ball-shaped fitting portion is provided at one of the shaft end portions of the supporting member.

7. The vehicle door opening and closing apparatus according to claim 3, wherein
the socket which can be demounted from the shaft end portion of the supporting member in a state of being fitted onto the ball-shaped fitting portion is provided at one of the shaft end portions of the supporting member.

8. The vehicle door opening and closing apparatus according to claim 4, wherein
the socket which can be demounted from the shaft end portion of the supporting member in a state of being fitted onto the ball-shaped fitting portion is provided at one of the shaft end portions of the supporting member.

9. The vehicle door opening and closing apparatus according to claim 1, wherein the supporting member includes a drive unit having a drive source and capable of expanding and contracting the supporting member integrated therein.

10. The vehicle door opening and closing apparatus according to claim 2, wherein the supporting member includes a drive unit having a drive source and capable of expanding and contracting the supporting member integrated therein.

11. The vehicle door opening and closing apparatus according to claim 3, wherein the supporting member includes a drive unit having a drive source and capable of expanding and contracting the supporting member integrated therein.

12. The vehicle door opening and closing apparatus according to claim 4, wherein the supporting member includes a drive unit having a drive source and capable of expanding and contracting the supporting member integrated therein.

13. The vehicle door opening and closing apparatus according to claim 5, wherein the supporting member includes a drive unit having a drive source and capable of expanding and contracting the supporting member integrated therein.

14. The vehicle door opening and closing apparatus according to claim 6, wherein the supporting member includes a drive unit having a drive source and capable of expanding and contracting the supporting member integrated therein.

15. The vehicle door opening and closing apparatus according to claim 7, wherein the supporting member includes a drive unit having a drive source and capable of expanding and contracting the supporting member integrated therein.

16. The vehicle door opening and closing apparatus according to claim 8, wherein the supporting member includes a drive unit having a drive source and capable of expanding and contracting the supporting member integrated therein.
